(19) United States
(12) Patent Application Publication
(10) Pub. No.: US 2008/0004891 A1
(43) Pub. Date: Jan. 3, 2008

(54) Product Information System

(75) Inventors: Peter Bostwick, Menlo Park, CA (US); Mason James Warner, Menlo Park, CA (US)

Correspondence Address: PERKINS COIE LLP, P.O. BOX 2168, MENLO PARK, CA, 94026, US

(73) Assignee: Certeli. Inc., Menlo Park, CA (US)

(21) Appl. No.: 11/768,143

(22) Filed: Jun. 25, 2007

Related U.S. Application Data
(60) Provisional application No. 60/806,459, filed on Jun. 30, 2006.

(51) Int. Cl. G06Q 99/00; G06F 17/30

(52) U.S. Cl. 705/1

(57) ABSTRACT

In various embodiments, a product information system is provided. In one embodiment, a system is presented. The system may have a variety of sources of data related to a distribution chain of a product. The system may also have a data aggregation module which combines data from the variety of sources of data. The system may further include a user interface for presentation of the combined data. The system may also include a user interface for collection or entry of data related to the distribution chain of the product.

### RELATED APPLICATIONS

This application claims priority to U.S. Provisional Patent Application No. 60/806,459, filed on Jun. 30, 2006, and entitled “Product Information System”, and is hereby incorporated herein by reference.

### BACKGROUND

Conventionally, consumers went to stores and purchased products. Some investigation or comparison shopping might be involved, and the consumer might test out the product at the store. However, if the product was not in the store, the only option was mail order through a catalog or manufacturer.

With the introduction of internet commerce, two new phenomena followed. One, consumers could do much research over the internet, making a near final determination about exactly what they wanted and then making an actual purchase in a tradition brick and mortar store. Two, consumers could try out a product at a brick and mortar store, using the store as a research resource, and then the consumer could go purchase the product on the internet, potentially at substantial savings.

The first development reduced or eliminated many opportunities for cross-selling (sales of additional products and services) and up-selling (sales of an alternative product or service). The second development resulted in sales people and other store resources being used more and more on consumers who would never buy a product at the store. Thus, the store might gain some sales, but those sales would have less potential for additional sales, and the store in turn spent more resources on non-revenue shoppers.

An alternative approach and system, that can induce customers to purchase items in a store and provide information about such items may thus be useful. Additionally, a system which can provide feedback about what products or services attract customers may be useful. Moreover, a system which can provide demographic information on customers and potential customers may be useful.

### BRIEF DESCRIPTION OF THE DRAWINGS

The present invention is illustrated by way of example in the accompanying drawings. The drawings should be understood as illustrative rather than limiting.

FIG. 1 illustrates an embodiment of a system for providing data to consumers.

FIG. 2 illustrates an embodiment of a process of providing data to consumers.

FIG. 3 illustrates an embodiment of a medium and data sources which may be used to implement a system or execute a method for providing data to consumers.

FIG. 4A illustrates an embodiment of a system for providing data to consumers and related data flow.

FIG. 4B illustrates an embodiment of a data structure for storage of data in the embodiment of FIG. 4A.

FIG. 5 illustrates an embodiment of a process of providing data to consumers.

FIG. 6A illustrates an embodiment of a user interface for providing data to consumers.

FIG. 6B illustrates another embodiment of a user interface for providing data to consumers.

FIG. 7 illustrates an embodiment of a network which may be used in providing data to consumers.

FIG. 8 illustrates an embodiment of a computer or machine which may be used in providing data to consumers.

FIG. 9 illustrates an embodiment of a process of providing data to consumers.

### DETAILED DESCRIPTION

A system, method and apparatus are provided for a product information system. The specific embodiments described in this document represent exemplary instances of the present invention, and are illustrative in nature rather than restrictive. In one embodiment, a system is presented. The system may have a variety of sources of data related to a distribution chain of a product. The system may also have a data aggregation module which combines data from the variety of sources of data. The system may further include a user interface for presentation of the combined data. The system may also include a user interface for collection or entry of data related to the distribution chain of the product.

In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Features and aspects of various embodiments may be integrated into other embodiments, and embodiments illustrated in this document may be implemented without all of the features or aspects illustrated or described.

Providing data to consumers may be advantageous for a variety of reasons. Such data may include product information along with pricing and availability information. However, such data may also include information about related products available in a store, information about discounts on a product, and information about package discounts on a set of products available at a store, for example. Thus, providing data to consumers can become a process by which the consumer's needs for information are met, and the store's needs to sell to consumer's are met.

Additionally, in the process of providing data to customers, needs of marketers can also be met. For example, marketers need to get information to customers, so the process or system potentially meets a need implicitly. Also, marketers need (or at least prefer) as much feedback information as they can get. Thus, marketers can get information about what products were chosen, what inquiries were made, how often information was presented, and potentially how often inspection of a product converted to a sale, for example.

Moreover, in some embodiments, identifying information for customers (actual and potential) can be collected. Various options such as a log in, accessing a loyalty card, or receiving volunteered personal information (e.g. a questionnaire or survey) can be used to get identifying information and/or demographic information. For purposes of this discussion, identifying information may be individual characteristics which provide specific identity data for a person, such as a government issued ID number (or identifier), a customer number, home/work address, or similar data. Similarly, demographic information may be more general attributes of a person such as postal code, age, gender, height, etc. Whether identifying information, demographic information or both is collected, this can be correlated to basic status information such as location in a store, location of a store, time of day and date of access, presence or absence of a product in store shelves and other similar information. Moreover, all of this information may be correlated in various embodiments.

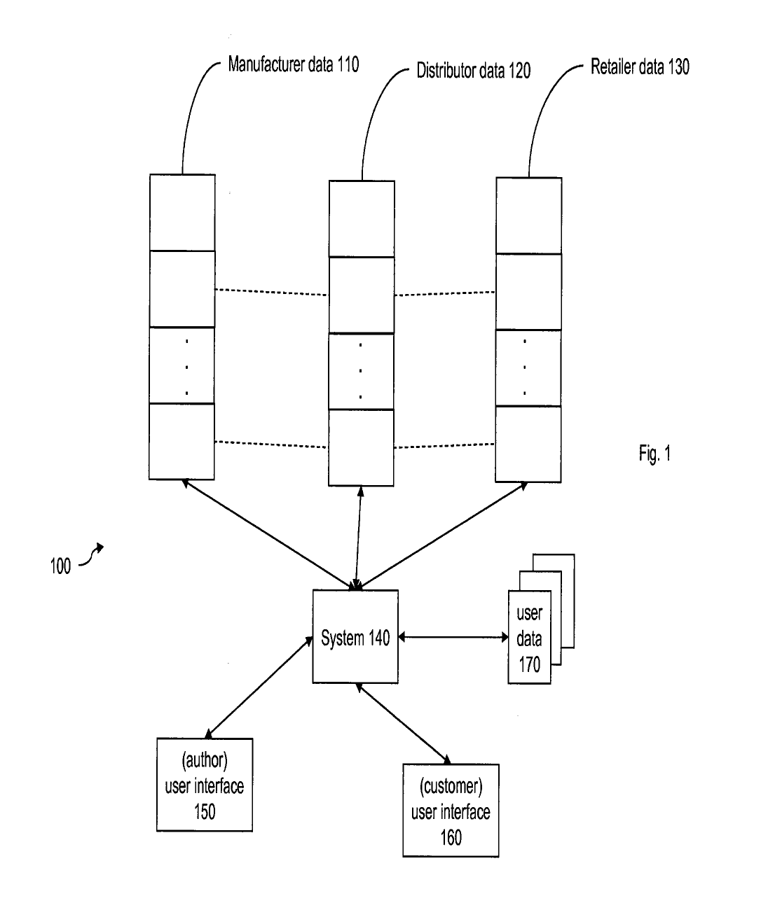

Various embodiments may be used to provide data to consumers. FIG. 1 illustrates an embodiment of a system for providing data to consumers. System 100 includes a server or similar system 140 which may access and process data. Data is held in manufacturer data 110, distributor data 120 and retailer data 130. Manufacturer data 1 10, distributor data 120 and retailer data 130 may all be part of a single repository, or may be spread around various data repositories, and may be split up in various different ways. Thus, manufacturer data 110, distributor data 120 and retailer data 130 represent logical portions of the overall data in the system. However, each of manufacturer data 110, distributor data 120 and retailer data 130 may represent a table or set of tables in a database, for example.

Sources of manufacturer data 110, distributor data 120 and retailer data 130 may be expected to be product manufacturers, product distributors and product retailers, respectively. However, one entity may occupy more than one of these roles. Retailers may be understood to refer to entities that actually sell a product or service, and thus would publish to the world (their consumers) any data from the system 100. However, the term retailers may generally refer to sellers of goods and services, including traditional retailers, retailers (sellers through e-commerce, for example) and other entities or people who sell goods and services through some form of sales outlet, for example.

To submit data, user interface 150 (an author user interface) may be used. Such a user interface may allow for identification of a product, group of products, product line, or other identifying information for one or more products and/or services. The user interface 150 may also allow for entry of data related to a product or service, and for creation of a new product or service within system 100. Additionally, the user interface 150 may allow for lookup of present data for a product or service, and editing of that data, with edited data resubmitted to a database, for example.

User interface 160 is a customer user interface—such as a terminal in a store or other point-of sale or point-of-decision type of location. User interface 160 may react to preprogrammed instructions, interaction by a customer, observation of a customer (such as through a motion sensor, for example), RFID detection of a customer (detecting a tag associated with a customer, whether individual or simply a foreign item in a part of a store), or some combination of such or other triggers. User interface may show information related to a product. That information may be drawn from manufacturer data 110, distributor data 120 and retailer data 130, and it may be drawn on a just-in-time basis (loaded when needed) or it may be drawn from such sources on a periodic basis, such as in a nightly download, for example.

Additionally, user interface 160 may allow for identification of a user, such as through swiping of a loyalty card in a magnetic card reader or exposure of an identification card to some form of an RFID reader, for example. With a user identified, a user profile 170 may be accessed. User profile 170 may contain personal identifying information, and may also include shopping history information. The shopping history information may be restricted to a specific store or may cross store boundaries when the system 100 is used in multiple stores.

Thus, system 140 may facilitate transfer of information (data) from manufacturer data 110, distributor data 120 and retailer data 130 to user interface 160 and to author user interface 150. Such information transfer may occur in an on-demand manner or may occur on a schedule for consumer user interface 160. For author user interface 150, a query-style on-demand access would be appropriate in many instances. Information from user profiles 170 may also be read and written in the process of consumer interaction.

Note that the logical organization of manufacturer data 110, distributor data 120 and retailer data 130 represents ownership of such data, to some degree. Thus, a manufacturer may enter manufacturer data 110 without concern about that data being tampered with by a distributor or retailer. As shown, each of manufacturer data 110, distributor data 120 and retailer data 130 have an entry for a product or service, and the entries in each table correspond to each other. This need not be the case. However, for any uniquely identified product or service, any entered data in manufacturer data 110, distributor data 120 and retailer data 130 generally would be accessible using an appropriate unique identifier. This allows system 140 to query data for a given product or service and to get associated data in an efficient manner.

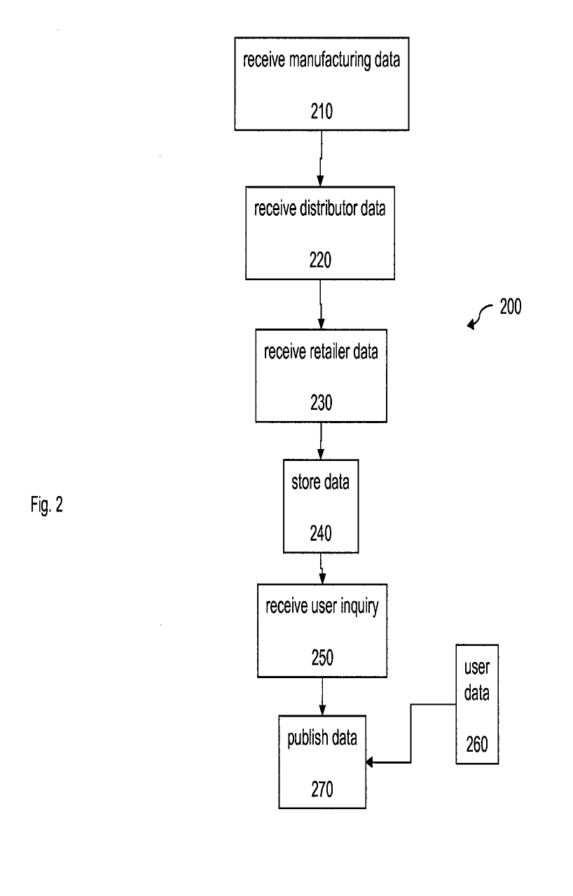

Storing and publishing data on a product or service is thus central to the system. FIG. 2 illustrates an embodiment of a process of providing data to consumers. Process 200 includes receiving manufacturing data, receiving distributor data, receiving retailer data, storing the data, receiving a user inquiry, publishing data, and may include use of user data. Process 200 and other processes of this document are implemented as a set of modules, which may be process modules or operations, software modules with associated functions or effects, hardware modules designed to fulfill the process operations, or some combination of the various types of modules, for example. The modules of process 200 and other processes described herein may be rearranged, such as in a parallel or serial fashion, and may be reordered, combined, or subdivided in various embodiments.

Process 200 initiates (as illustrated) with receipt of manufacturer data at module 210. Next, distributor data is received at module 220 and retailer data is received at module 230. As illustrated, this is a linear, ordered process. However, these modules may be rearranged in terms of order, or may be rearranged into a parallel process. Moreover, such data may be received on a regular or irregular basis, such as through a scheduled upload into a database or through essentially random use of a user interface.

Data received is stored in a database at module 240. At module 250, a user inquiry about data is received. This may be one of at least two forms. A user inquiry may involve a request for data from a store or publisher of data for purposes of updating an in-store system with current data, for example. Such a request may be expected to occur on a regular, predetermined basis in many embodiments. A user inquiry may alternately relate to an interaction with a user, such as a user requesting information through a user interface, a user swiping or otherwise presenting a loyalty card, or a user being sensed near a terminal, for example. Responsive to the user inquiry, data is retrieved and published to the user at module 270. In the case of a user who is identified (such as through a loyalty card), module 260 may provide user-specific data.

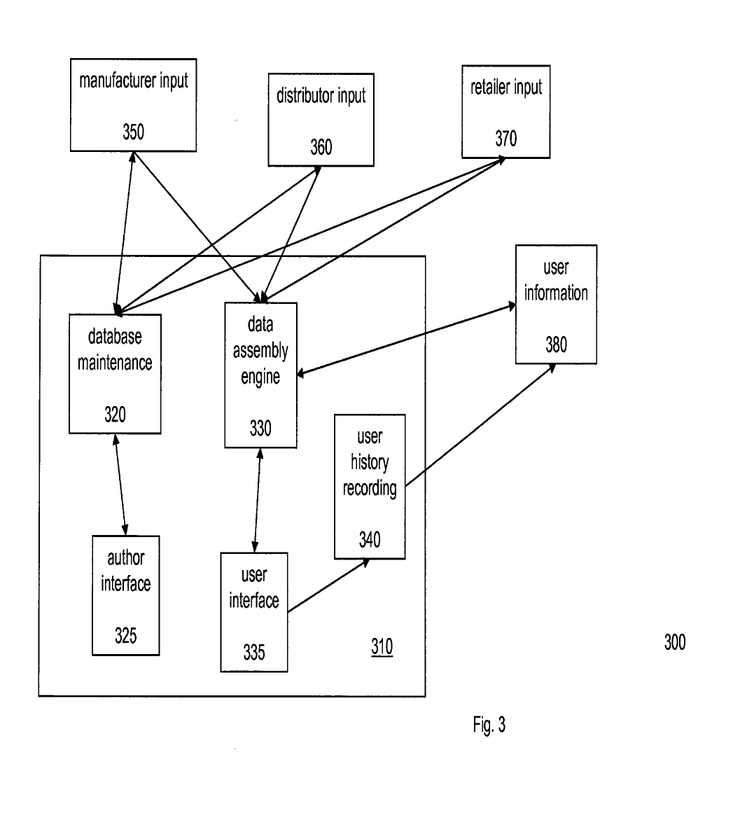

The system and method illustrated can be implemented in a software system. FIG. 3 illustrates an embodiment of a medium and data sources which may be used in a system for providing data to consumers. A machine-readable medium may embody modules which may be executed by a system to configure a system or implement a method, for example. System 300 includes medium 310 and a variety of data sources.

Medium 310 includes database maintenance module 320. Module 320 interacts with author user interface 325 to get requests for data and new data. Module 320 also interacts with manufacturer input 350, distributor input 360 and retailer input 370, requesting existing data and providing new or updated data. Thus, the inputs 350, 360 and 370 represent data stores such as databases, for example.

Medium 310 also includes data assembly engine 330. Engine 330 interacts with user interface 335 to provide information to customers and receive requests for information. Engine 330 also receives information from inputs 350, 360 and 370, responsive to requests for data. However, the flow of information is principally from the inputs 350, 360 and 370 to the engine 330. Data assembly engine 330 also interacts with user information 380, which may include user-specific information for identified users. Thus, presentation of data to a user may be customized based on history, preference or privilege information found in user information 380, for example. This may be as simple as altering how information is presented to as complex as providing special offers or packages; or alternate information based on a user's history or status, for example.

User information 380 may be maintained by user history recording module 340 of media 310, for example. Module 380 may simply record user activities or purchases, or it may interact with the user through user interface 335 to request feedback and/or preferences, for example. User information 380 may have other sources, such as corporate information stores with data about privileged customers and employees, for example.

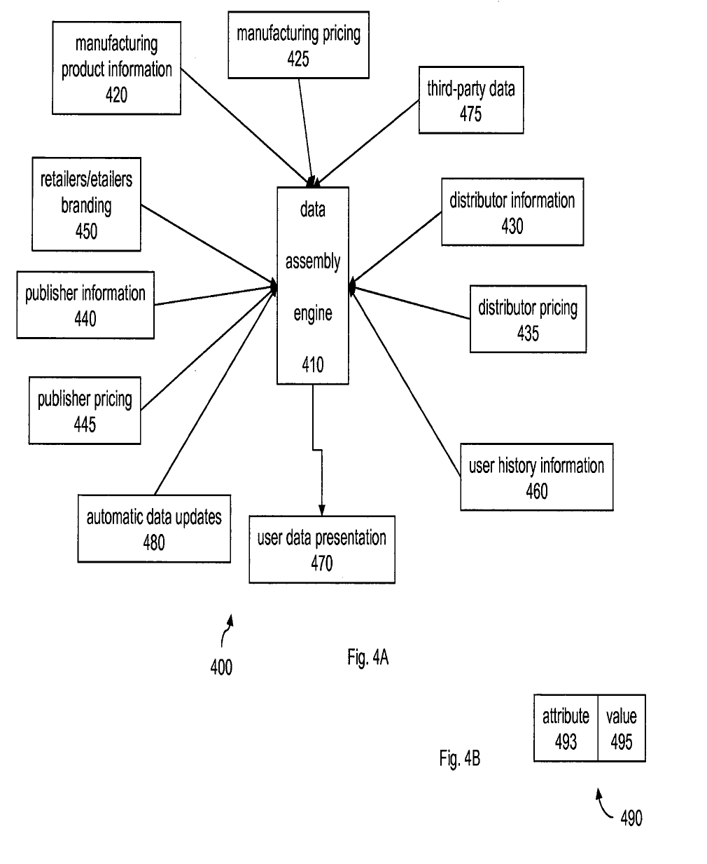

An alternate data assembly engine may provide an example of the different types of data which may be assembled into a presentation to a user. FIG. 4A illustrates an embodiment of a system for providing data to consumers and related data flow. System 400 involves flow of data to data assembly engine 410 from a variety of sources and outflow of that data in a transformed format to a user data presentation module 470.

Thus, engine 410 may receive manufacturer data in the form of manufacturer product information 420 and manufacturer pricing information 425. This may provide baseline data on a product, for example. Furthermore, this may provide a manufacturer's suggested retail price (MSRP) and a manufacturer's description of a product. Also, this may provide information about what products should be linked together within a system. Thus, a maker of camera bags can indicate what cameras are suitable for use with a given camerabag (based on manufacturer suggestions or design, e.g.) Such linkage may be a feature of the system in some embodiments, or may be a premium feature of the system in other embodiments. Moreover, as with the camera and camera bag example, the linked products may come from different manufacturers—the camera bag linker may link to cameras of a number of other manufactures, for example.

Note that manufacturers in this case may refer to a broader array of entities than simply the true manufacturer. Thus, a company marketing a product may appear to be a manufacturer, even though actual manufacturing is handled by a separate company or division. Moreover, manufacturers may provide part of a product line originally and re-brand or re-label part of a product line. However, manufacturers may be contrasted from distributors in this description as distributors may be expected to distribute products labeled or branded by others. Both manufacturers and distributors may be marketers.

Engine 410 may also receive distributor information 430 and distributor pricing information 435. Thus, a distributor may provide a more localized description of a product, potentially using local idiom or emphasizing regional customs. Moreover, a distributor may provide altered pricing, such as a discount or markup of an MSRP, for example. This information may overlay, overwrite, or supplement manufacturer information for a specific data presentation, but will have no effect on manufacturer information stored in the system.

Engine 410 may also receive retailer information 440, retailer pricing information 445 and retailer branding information 450. Thus, a retailer can provide further information, such as information about related products in a store or available services (e.g. a store warranty or refund policy). Moreover, a retailer can provide in-store pricing information, indicating the actual price in the store (and potentially any discount). Additionally, the retailer may provide a branding format (e.g. skin or layout) and other branding information. All of this material may be overlaid or otherwise combined with manufacturer and distributor information by the engine 410.

Engine 410 may also factor in data such as a geographic location (general or specific), time of day, demographics of a user if available, even identity of a user if available. Other similar data may be factored in, too. Such data may result in a time-sensitive or location-sensitive discount, for example. Similarly, such data may result in a loyalty-based or geographically-based discount, for example.

Along with factoring in such data, engine 410 may receive regular data updates 480. Such automatic updates 480 may represent data pushed through the system or may represent updates from actual sources of data, such as manufacturers, distributors or retailers, for example. Also, engine 410 may receive data from third-party data sources 475, such as advertising agencies, third-party consultants, and media such as magazines, for example. Thus, the data available for presentation may be updated automatically, and may include data which was specified by one of the three main sources (e.g. manufacturer, distributor or retailer), but was actually supplied by a third-party. A magazine review or advertising graphics are examples of such data.

The engine 410 then provides the combined information to user data presentation module 470. Module 470 may be an interface to peripherals forming a user interface, for example. Alternatively, module 470 may be a local system coupled to a user interface or a set of user interfaces, for example.

All of the data from the various sources of FIG. 4A must be stored. FIG. 4B illustrates an embodiment of a data structure for storage of data in the embodiment of FIG. 4A. Data structure 490 includes an attribute 493 and an associated value 495. Each such data structure 490 may either be associated with a product or service, or may additionally encode an associated product or service (not shown). As examples of what type of information may be included, the following tables provide lists of attributes for:

Wine

| | | |
|---|---|---|
| Winery name | Wine name | Vintage |
| Primary varietal | Brix at Harvest | Total Acidity |
| pH | Alcohol (content/level) | Release Date |
| Number of cases | Bottle image | Shelf talker image |
| produced | | |
| UPC code | Appellation | Region |
| Tasting notes | Winemaker notes | Winery notes |
| Technical notes | Food pairings | SKU |

Appliances

| | | |
|---|---|---|
| SKU | Name | Appliance type |
| Appliance sub-type | Model number | Color |
| Color options | Power | Width |
| Height | Depth | Feature notes |
| Style notes | Warranty | Burner options |
| Number of drawers | | |

Note that not all products of a certain type will have the same attributes. For example, an air conditioner would not have a number of drawers (typically) while it may still be an appliance. Similarly, a wine need not have winery notes or technical notes, for example.

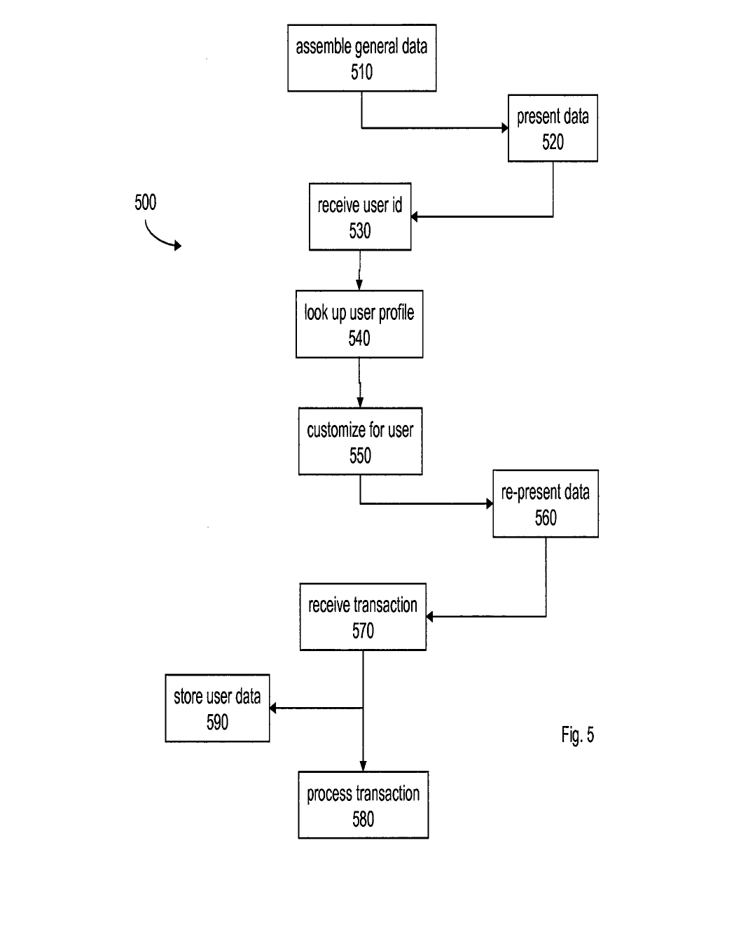

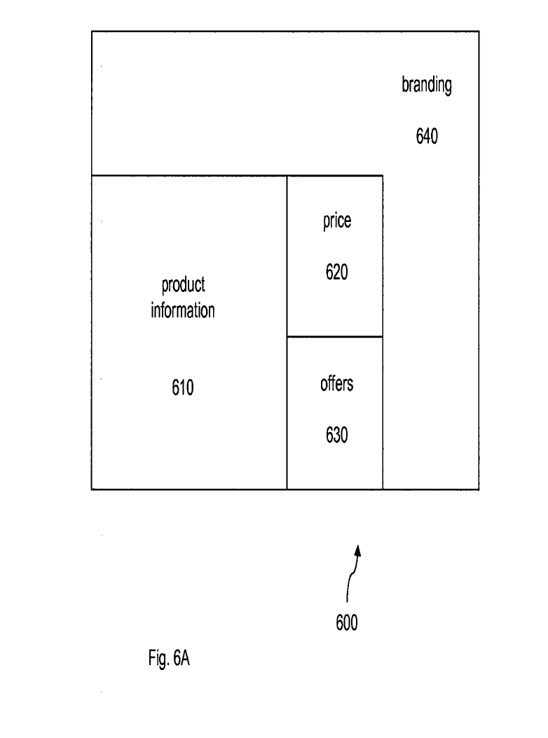

While the process of adding and accessing data related to products has been described in some detail, the process of completing a transaction may also provide further details. FIG. 5 illustrates an embodiment of a process of providing data to consumers. Process 500 includes assembling general data about a product or service, presenting data, receiving a user identifier, looking up a user profile, customizing a presentation for the user, re-presenting the data, receiving a transaction, processing the transaction, and potentially storing user data.

Process 500 initiates with assembly of general data for presentation at module 510. That data is presented at module 520. A user identifier may be received at module 530, such as through swiping a loyalty card or logging into a system, for example. With the user identifier or identification, an associated user profile is looked up at module 540. The user profile is then used to customize the data presentation for the user at module 550, such as by offering special promotions or providing a personalized presentation of data. At module 560, the customized data is presented to the user.

Should the user choose to purchase the product or service, a transaction is received at module 570. This may be through the user acknowledging a purchase will occur by taking an item off of a shelf and placing it in a cart, or it may involve an actual purchase. At module 580, the transaction is processed, such as through an actual purchase or through placement of a purchase on a user account. Also, at module 590, user data related to the transaction is stored. This may involve querying the user for consent to store the data. Alternatively, it may be automatic upon purchase or upon selection of an item or a service. Moreover, data may be stored related to various actions, such as selection, purchase and return of a product or service. This user data may then be used for later display customization purposes, for example.

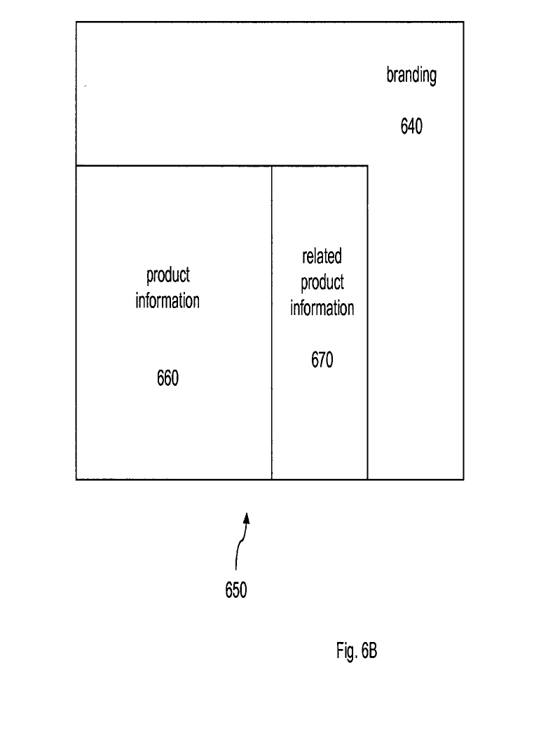

Actual display of information may provide further details about the system and methods. FIG. 6A illustrates an embodiment of a user interface for providing data to consumers. Interface 600 represents a graphical user interface or screen on which data may be displayed. Product information 610 may include basic information such as a product name, picture, manufacturer, and may further include additional information about the product. Price 620 may provide the applicable price of the product. Price 620 may change over time, and may also reflect various discounts or markups along the chain by which the product gets from producer to consumer. Offers 630 may illustrate offers of discounts, package deals, or indications of scarcity (e.g. “only two left at this price”). Branding 640, as illustrated, is a skin or overall brand provided on the display 600. This may have theme colors and logos for a store, for example, or may be varied in different departments.

Alternatively, a different format may be appropriate in other situations. FIG. 6B illustrates another embodiment of a user interface for providing data to consumers. Interface 650 may include a similar branding portion 640, but also include product information 660 and related product information 670, for example. Thus, product information 660 may include basic details about the product, similar to product information 610. Product information 660 may also include information about how the subject product fits into a system or family of products, for example. Similarly, related product information 670 may provide information about specific related products which are complementary or synergistic with the subject product of product information 660. Alternatively, related product information 670 may include information about an overall system into which the subject product of product information 660 fits, for example. Thus, interface 650 may primarily provide an opportunity to cross-sell or up-sell a customer.

The system and methods described allow for the possibility of revenue or payment in a variety of ways. In one embodiment, retailers pay for the computer/kiosk network on which the system is implemented, maintenance of the in-store network and potentially any back-office equipment. Moreover, retailers may pay for maintenance and update of content—through a subscription service or airtime/network usage charges, for example.

Similarly, marketers may pay for access to the network, for their content (potentially on a storage space-basis or a pay-per-view basis, for example). As noted, marketers may pay for the ability to link to other products and services. Marketers may also pay for ranking of their products and services (sponsored positions, for example). Additionally, marketers may pay for showing of commercials or other extended data for a product or service displayed on the network.

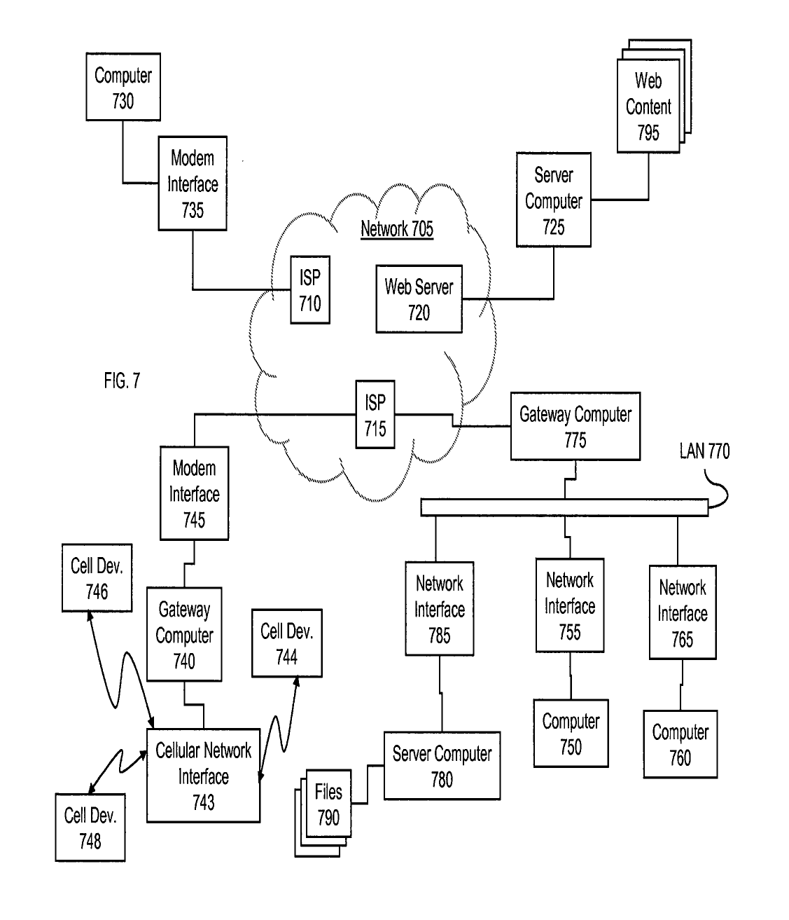

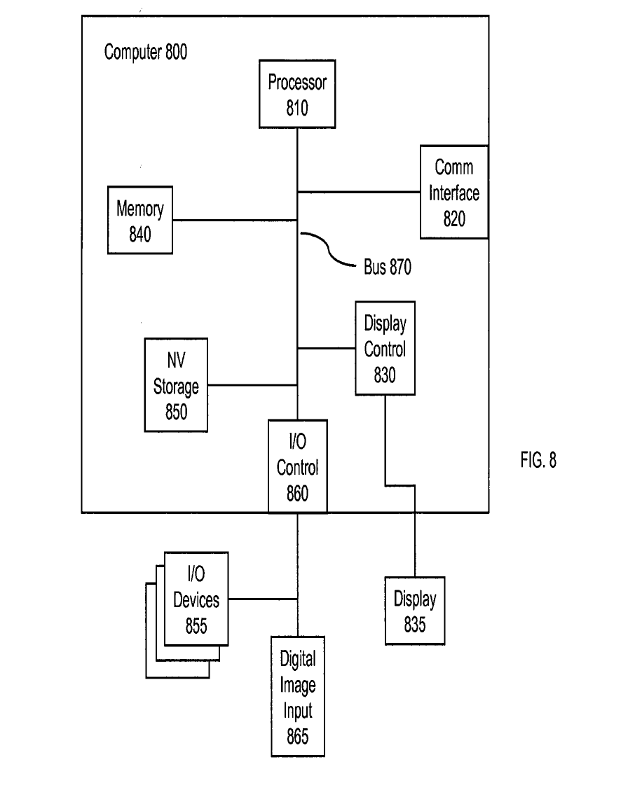

FIG. 7 illustrates an embodiment of a network which may be used in providing data to consumers. FIG. 8 illustrates an embodiment of a computer or machine which may be used in providing data to consumers. The following description of FIGS. 7-8 is intended to provide an overview of device hardware and other operating components suitable for performing the methods of the invention described above and hereafter, but is not intended to limit the applicable environments. Similarly, the hardware and other operating components may be suitable as part of the apparatuses described above. The invention can be practiced with other system configurations, including personal computers, multiprocessor systems, microprocessor-based or programmable consumer electronics, network PCs, minicomputers, mainframe computers, and the like. The invention can also be practiced in distributed computing environments where tasks are performed by remote processing devices that are linked through a communications network.

FIG. 7 shows several computer systems that are coupled together through a network 705, such as the internet, along with a cellular network and related cellular devices. The term “internet” as used herein refers to a network of networks which uses certain protocols, such as the TCP/IP protocol, and possibly other protocols such as the hypertext transfer protocol (HTTP) for hypertext markup language (HTML) documents that make up the world wide web (web). The physical connections of the internet and the protocols and communication procedures of the internet are well known to those of skill in the art.

Access to the internet 705 is typically provided by internet service providers (ISP), such as the ISPs 710 and 715. Users on client systems, such as client computer systems 730, 750, and 760 obtain access to the internet through the internet service providers, such as ISPs 710 and 715. Access to the internet allows users of the client computer systems to exchange information, receive and send e-mails, and view documents, such as documents which have been prepared in the HTML format. These documents are often provided by web servers, such as web server 720 which is considered to be “on” the internet. Often these web servers are provided by the ISPs, such as ISP 710, although a computer system can be set up and connected to the internet without that system also being an ISP.

The web server 720 is typically at least one computer system which operates as a server computer system and is configured to operate with the protocols of the world wide web and is coupled to the internet. Optionally, the web server 720 can be part of an ISP which provides access to the internet for client systems. The web server 720 is shown coupled to the server computer system 725 which itself is coupled to web content 795, which can be considered a form of a media database. While two computer systems 720 and 725 are shown in FIG. 7, the web server system 720 and the server computer system 725 can be one computer system having different software components providing the web server functionality and the server functionality provided by the server computer system 725 which will be described further below.

Cellular network interface 743 provides an interface between a cellular network and corresponding cellular devices 744, 746 and 748 on one side, and network 705 on the other side. Thus cellular devices 744, 746 and 748, which may be personal devices including cellular telephones, two-way pagers, personal digital assistants or other similar devices, may connect with network 705 and exchange information such as email, content, or HTTP-formatted data, for example.

Cellular network interface 743 is representative of wireless networking in general. In various embodiments, such an interface may also be implemented as a wireless interface such as a Bluetooth interface, IEEE 802.11 interface, or some other form of wireless network. Similarly, devices such as devices 744, 746 and 748 may be implemented to communicate via the Bluetooth or 802.11 protocols, for example. Other dedicated wireless networks may also be implemented in a similar fashion.

Cellular network interface 743 is coupled to computer 740, which communicates with network 705 through modem interface 745. Computer 740 may be a personal computer, server computer or the like, and serves as a gateway. Thus, computer 740 may be similar to client computers 750 and 760 or to gateway computer 775, for example. Software or content may then be uploaded or downloaded through the connection provided by interface 743, computer 740 and modem 745.

Client computer systems 730, 750, and 760 can each, with the appropriate web browsing software, view HTML pages provided by the web server 720. The ISP 710 provides internet connectivity to the client computer system 730 through the modem interface 735 which can be considered part of the client computer system 730. The client computer system can be a personal computer system, a network computer, a web TV system, or other such computer system.

Similarly, the ISP 715 provides internet connectivity for client systems 750 and 760, although as shown in FIG. 7, the connections are not the same as for more directly connected computer systems. Client computer systems 750 and 760 are part of a LAN coupled through a gateway computer 775. While FIG. 7 shows the interfaces 735 and 745 as generically as a “modem,” each of these interfaces can be an analog modem, isdn modem, cable modem, satellite transmission interface (e.g. “direct PC”), or other interfaces for coupling a computer system to other computer systems.

Client computer systems 750 and 760 are coupled to a LAN 770 through network interfaces 755 and 765, which can be ethernet network or other network interfaces. The LAN 770 is also coupled to a gateway computer system 775 which can provide firewall and other internet related services for the local area network. This gateway computer system 775 is coupled to the ISP 715 to provide internet connectivity to the client computer systems 750 and 760. The gateway computer system 775 can be a conventional server computer system. Also, the web server system 720 can be a conventional server computer system.

Alternatively, a server computer system 780 can be directly coupled to the LAN 770 through a network interface 785 to provide files 790 and other services to the clients 750, 760, without the need to connect to the internet through the gateway system 775.

FIG. 8 shows one example of a personal device that can be used as a cellular telephone (744, 746 or 748) or similar personal device, or may be used as a more conventional personal computer, as an embedded processor or local console, or as a PDA, for example. Such a device can be used to perform many functions depending on implementation, such as monitoring functions, user interface functions, telephone communications, two-way pager communications, personal organizing, or similar functions. The system 800 of FIG. 8 may also be used to implement other devices such as a personal computer, network computer, or other similar systems. The computer system 800 interfaces to external systems through the communications interface 820. In a cellular telephone, this interface is typically a radio interface for communication with a cellular network, and may also include some form of cabled interface for use with an immediately available personal computer. In a two-way pager, the communications interface 820 is typically a radio interface for communication with a data transmission network, but may similarly include a cabled or cradled interface as well. In a personal digital assistant, communications interface 820 typically includes a cradled or cabled interface, and may also include some form of radio interface such as a Bluetooth or 802.11 interface, or a cellular radio interface for example.

The computer system 800 includes a processor 810, which can be a conventional microprocessor such as an Intel Pentium microprocessor or Motorola power PC microprocessor, a Texas Instruments digital signal processor, or some combination of the two types or processors. Memory 840 is coupled to the processor 810 by a bus 870. Memory 840 can be dynamic random access memory (dram) and can also include static ram (sram), or may include FLASH EEPROM, too. The bus 870 couples the processor 810 to the memory 840, also to non-volatile storage 850, to display controller 830, and to the input/output (I/O) controller 860. Note that the display controller 830 and I/O controller 860 may be integrated together, and the display may also provide input.

The display controller 830 controls in the conventional manner a display on a display device 835 which typically is a liquid crystal display (LCD) or similar flat-panel, small form factor display. The input/output devices 855 can include a keyboard, or stylus and touch-screen, and may sometimes be extended to include disk drives, printers, a scanner, and other input and output devices, including a mouse or other pointing device. The display controller 830 and the I/O controller 860 can be implemented with conventional well known technology. A digital image input device 865 can be a digital camera which is coupled to an I/O controller 860 in order to allow images from the digital camera to be input into the device 800.

The non-volatile storage 850 is often a FLASH memory or read-only memory, or some combination of the two. A magnetic hard disk, an optical disk, or another form of storage for large amounts of data may also be used in some embodiments, though the form factors for such devices typically preclude installation as a permanent component of the device 800. Rather, a mass storage device on another computer is typically used in conjunction with the more limited storage of the device 800. Some of this data is often written, by a direct memory access process, into memory 840 during execution of software in the device 800. One of skill in the art will immediately recognize that the terms “machine-readable medium” or “computer-readable medium” includes any type of storage device that is accessible by the processor 810 and also encompasses a carrier wave that encodes a data signal.

The device 800 is one example of many possible devices which have different architectures. For example, devices based on an Intel microprocessor often have multiple buses, one of which can be an input/output (I/O) bus for the peripherals and one that directly connects the processor 810 and the memory 840 (often referred to as a memory bus). The buses are connected together through bridge components that perform any necessary translation due to differing bus protocols.

In addition, the device 800 is controlled by operating system software which includes a file management system, such as a disk operating system, which is part of the operating system software. One example of an operating system software with its associated file management system software is the family of operating systems known as Windows CE® and Windows® from Microsoft Corporation of Redmond, Wash., and their associated file management systems. Another example of an operating system software with its associated file management system software is the Palm® operating system and its associated file management system. The file management system is typically stored in the non-volatile storage 850 and causes the processor 810 to execute the various acts required by the operating system to input and output data and to store data in memory, including storing files on the non-volatile storage 850. Other operating systems may be provided by makers of devices, and those operating systems typically will have device-specific features which are not part of similar operating systems on similar devices. Similarly, WinCE® or Palm® operating systems may be adapted to specific devices for specific device capabilities.

Device 800 may be integrated onto a single chip or set of chips in some embodiments, and typically is fitted into a small form factor for use as a personal device. Thus, it is not uncommon for a processor, bus, onboard memory, and display/I-O controllers to all be integrated onto a single chip. Alternatively, functions may be split into several chips with point-to-point interconnection, causing the bus to be logically apparent but not physically obvious from inspection of either the actual device or related schematics.

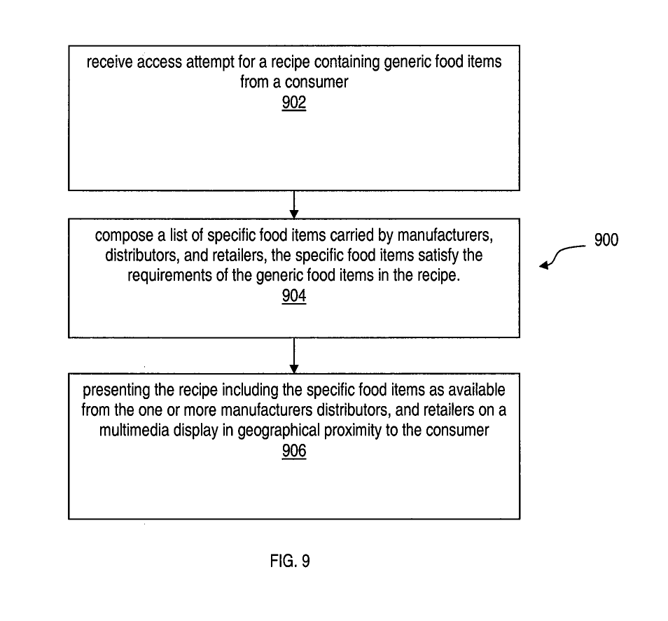

FIG. 9 illustrates an embodiment of a process 900 of providing data to consumers. Process 900 includes receiving an access attempt for a recipe for preparing a culinary dish, composing a list of specific food items, and presenting the recipe including the specific food items as available from one or more manufacturers. Process 900 and other processes of this document are implemented as a set of modules, which may be process modules or operations, software modules with associated functions or effects, hardware modules designed to fulfill the process operations, or some combination of the various types of modules, for example. The modules of process 900 and other processes described herein may be rearranged, such as in a parallel or serial fashion, and may be reordered, combined, or subdivided in various embodiments.

Process 900 initiates (as illustrated) with receipt an access attempt for a recipe at module 902. A “culinary dish” means any food a recipe can be used to prepare. E.g. pumpkin pie is a culinary dish.

At module 904, compose a list of specific food items carried by manufacturers, distributors, and retailers. E.g., pumpkins canned by a specified cannery are available from a specified store. Flour and sugar are also available from specified manufacturers, distributors, and/or retailers. The pumpkin, flour, and sugar are each listed with manufacturers, distributors, and or/retailers selling that carry pumpkin, flour, and sugar.

At module 906, present the recipe including the specific food items as available from the manufacturers, distributors, or retailers. In continuing the example, the user will be able to see not only how to make the exemplary pumpkin pie, but also where to purchase the ingredients.

In an illustrative embodiment, the list of specific food items contains brand names that are listed in an order. The list may contain one or more specific food items for each generic food item. E.g. super-flour is a fictitious brand name for wheat flour. Super-flour is available from retailer A, retailer B, and retailer C as well as distributor A, distributor B, or distributor C. Further, it would be possible to present a list including distributors, retailers and manufacturers, such as super-flour is available from manufacturer E, distributor C, and retailer G. In ordering the brand names, a number of different criteria could be used. In an illustrative embodiment, manufacturers, retailers, and distributors are ranked by the amount of money paid to be ranked.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention, in some embodiments, also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language, and various embodiments may thus be implemented using a variety of programming languages.

One skilled in the art will appreciate that although specific examples and embodiments of the system and methods have been described for purposes of illustration, various modifications can be made without deviating from the present invention. For example, embodiments of the present invention may be applied to many different types of databases, systems and application programs. Moreover, features of one embodiment may be incorporated into other embodiments, even where those features are not described together in a single embodiment within the present document.

What is claimed is:

1. A method, comprising:
receiving an access attempt from a consumer;
composing information related to a product or service implicated by the access attempt, the information from one or more of manufacturers, distributors and retailers; and
presenting the information to the consumer on a multimedia display in geographical proximity to the consumer.

2. The method of claim 1, wherein:
the multimedia display is in a store.

3. The method of claim 2, wherein:
the product implicated by the access attempt is physically close to the multimedia display.

4. The method of claim 2, wherein:
the product implicated by the access attempt is physically away from the multimedia display.

5. The method of claim 2, further comprising:
receiving data from a manufacturer of the product implicated by the access attempt.

6. The method of claim 2, further comprising:
receiving data from a distributor of the product implicated by the access attempt.

7. The method of claim 2, further comprising:
receiving data from a retailer of the product implicated by the access attempt.

8. The method of claim 2, wherein:
the access attempt results from detection of physical proximity of the consumer.

9. The method of claim 2, wherein:
the access attempt results from detection of an item carried by the consumer.

10. The method of claim 2, wherein:
the access attempt results from swiping of a loyalty card with the system, the loyalty card associated with the consumer.

11. The method of claim 2, wherein:
the access attempt results from a request from the consumer.

12. The method of claim 2, wherein:
the access attempt results from a log in access by the consumer.

13. The method of claim 2, further comprising:
receiving periodic updates of information related to products or services.

14. The method of claim 1, further comprising:
receiving data from a manufacturer of the product implicated by the access attempt;
receiving data from a distributor of the product implicated by the access attempt;
receiving data from a retailer of the product implicated by the access attempt; and
receiving periodic updates of information related to products or services.

15. The method of claim 1, wherein:
the access attempt by the consumer is for a recipe listing generic food items and cooking procedures for preparing a culinary dish; and
the information composed is a list comprising one or more non-generic, specific food items carried by one or more of the manufacturers, distributors, and retailers satisfying the requirements of the generic food items in the recipe.

16. The method of claim 15, wherein:
the non-generic, specific food items in the list include current inventory items in stock at one or more of the manufacturers, distributors, and retailers.

17. The method of claim 16, wherein:
the current inventory items are listed in order of rankings according to brand names of the current inventory items.

18. The method of claim 1, wherein:
the method is implemented by a processor, the processor executing responsive to a set of instructions of a machine-readable medium, the set of instructions embodying the method in processor-executable form.

19. The method of claim 18, wherein:
the access attempt by the consumer is for a recipe listing generic food items and cooking procedures for preparing a culinary dish; and
the information composed is a list comprising one or more non-generic, specific food items carried by one or more of the manufacturers, distributors, and retailers satisfying the requirements of the generic food items in the recipe.

20. The method of claim 19, wherein:
the non-generic, specific food items in the list include current inventory items in stock at one or more of the manufacturers, distributors, and retailers.

21. The method of claim 20, wherein:
the current inventory items are listed in order of rankings according to brand names of the current inventory items.

22. A method, comprising:
receiving data from a manufacturer of a product;
receiving data from a distributor of the product;
receiving data from a retailer of the product;
receiving periodic updates of information related to the products;
receiving an access attempt from a consumer;
composing information related to the product, the product implicated by the access attempt, the information from one or more of the manufacturer, the distributor and the retailer; and
presenting the information to the consumer on a multimedia display in physical proximity to the consumer.

23. The method of claim 22, wherein:
the access attempt by the consumer is for a recipe listing generic food items and cooking procedures for preparing a culinary dish; and
the information composed is a list comprising one or more non-generic, specific food items carried by one or more of the manufacturers, distributors, and retailers satisfying the requirements of the generic food items in the recipe.

24. The method of claim 23, wherein:
the non-generic, specific food items in the list include current inventory items in stock at one or more of the manufacturers, distributors, and retailers.

25. The method of claim 24, wherein:
the current inventory items are listed in order of rankings according to brand names of the current inventory items.
